(19) United States
(12) Patent Application Publication
(10) Pub. No.: US 2011/0218854 A1
(43) Pub. Date: Sep. 8, 2011

(54) System, Apparatus and Method of Optimizing Facility Usage Capacity

(76) Inventor: David Seth Shamlian, Albany, NY (US)

(21) Appl. No.: 12/985,844

(22) Filed: Jan. 6, 2011

(51) Int. Cl. G06F 17/30; G06Q 30/00

(52) U.S. Cl. 705/14.49; 707/769; 707/E17.014

(57) ABSTRACT

The excess capacity system is configured to offer an improved method and system for optimally utilizing excess capacity of an institution. In response to a search by a user the facility optimizer system of the excess capacity system will retrieve facility from providers. The facility optimizer system may also determine if the user is prequalified by criteria required by a facility provider.

### FIELD OF THE DISCLOSURE

Embodiments disclosed herein relate to a system, apparatus and method of optimizing facility capacity usage.

### BACKGROUND

The use of the Internet offers a variety of benefits to everyone who is willing to use it. The enormous amount of information available and the many uses one can have through the Internet have made it a valuable tool in various settings of a person's life. Access to the Internet is rapidly becoming more important in today's current environment. Internet access enables users to perform a wide variety of tasks from seeing what the best prices are out there to finding solutions from others who have had similar experiences.

### SUMMARY

In an aspect of the disclosure herein, a system comprising: a communications interface adapted to interface with a network; at least one processor coupled to the communications interface and adapted to: receive facility information from a plurality of facilities wherein said facility information includes recreation zones; receive a facility search request from a user; search at least one database to determine if there is a match with the facility search and send the response to the user; and receive a request to reserve at least one of the recreation zones within the plurality of facilities from the user. In another aspect, the system determines if the user is prequalified. In another aspect, the system determines if the user is prequalified by determining if the user has insurance. In another aspect, the system matches the facility information with additional services provided by the system. In another aspect, the facility information includes capacity information. In another aspect, the facility information includes facility offered services. In another aspect, the facility information will include a map showing the exact location of the recreation zone within the facility. In another aspect, the system includes a website which provides advertising that corresponds to the type of facility being searched by the user. In another aspect, the facility is a university. In another aspect, the facility is a community golf course. In another aspect, the additional services offered by the system include insurance coverage. In another aspect, the system receives from the user whether they are at least one of an associated customer, a preferred customer, and a general public customer. In another aspect, the facility offered services includes providing rental equipment. In another aspect, the system is further configured to send an inclement weather warning to a user with an offer to re-schedule their rental of the facility. In another aspect, the system is linked with an interactive weather service and receives a warning against danger which is then sent from the system to the users and/or the facility provider. In another aspect, the system is configured to send a change request to a user along with a discount on their next rental. In another aspect, the system is adapted to offer additional facility if the first facility choice is occupied. In another aspect, the system provides a policing function by banning users who do not follow the rules of the facility. In another aspect, the system receives information from the plurality of facilities which includes the first date the facility may be available to an associated customer, the second date the facility may be available to a preferred customer, and the third date the facility may be available to general public. In another aspect, the facility information includes a list of prequalified customers. In another aspect, the site is configured to offer up additional sites or times in the same geographic region in case the original choice is not available. In another aspect, wherein ratings of the field sites are made by users of the systems. In another aspect, wherein the facility and recreation zones may be ranked by price (high or low), user ratings, closeness, and/or size. In another aspect, system might inform the facility operator that the site has not been rented in a certain length of time and a suggestion to drop their price. In another aspect, wherein the system might inform an email list of the status of the reservation. In another aspect, wherein a user can reserve a facility and then indicate on the rental that they need a partner. In another aspect, wherein a recommendation can be placed next to the website of service providers once the facility is reserved. In another aspect, wherein insurance can be offered to users who do not have their own insurance.

In another aspect of the disclosure, a method comprising: receiving facility information from a plurality of facilities wherein said facility information includes a plurality of recreation zones; receive a facility search request from a user; searching at least one database to determine if there is an approximate match with the facility search and send the response to the user; and receiving a request to reserve at least one of the recreation zones within the plurality of facilities. In another aspect, receiving videos from users and storing them in an augmented reality format. In another aspect, sending a request to a user asking if the user is a prequalified customer. In another aspect, sending a request to a user inquiring if they are covered by insurance. In another aspect, sending advertising to the user's display based on the location of the facility search request. In another aspect, wherein the facility information may include a map with the recreation zones indicated. In another aspect, receiving ratings from a plurality of users; and sending recommendations to a display on the price for rental of at least one of the recreation zones based on the ratings received from a plurality of users.

In another aspect of the disclosure, a method comprising: receiving facility information from a plurality of facilities wherein said facility information includes a plurality of recreation zones; receive a facility search request from a user; sending a request to a user asking if the user is a prequalified customer; searching at least one database to determine if there is an approximate match with the facility search and send the response to the user; receiving a request to reserve at least one of the recreation zones within the plurality of facilities; and sending advertising to the user's display in a dynamic way from regional to local advertisers.

In another aspect of the disclosure, a computer program product, comprising a computer usable medium having a computer readable program code embodied therein, said computer readable program code adapted to: receive facility information from a plurality of facilities wherein said facility information includes recreation zones; receive a facility search request from a user; search at least one database to determine if there is a match with the facility search and send the response to the user; and receive a request to reserve at least one of the recreation zones within the plurality of facilities from the user. In another aspect, the system determines if the user is prequalified. In another aspect, the system determines if the user is prequalified by determining if the user has insurance.

A computer program comprising a computer usable medium having a computer readable program code embodied therein, said computer readable program code configured to: receive facility information from a plurality of facilities wherein said facility information includes a plurality of recreation zones; receive a facility search request from a user; search at least one database to determine if there is an approximate match with the facility search and send the response to the user; and receive a request to reserve at least one of the recreation zones within the plurality of facilities. In another aspect, receiving videos from users and storing them in an augmented reality format. In another aspect, sending a request to a user asking if the user is a prequalified customer. In another aspect, sending a request to a user inquiring if they are covered by insurance. In another aspect, sending advertising to the user's display based on the location of the facility search request. In another aspect, wherein the facility information may include a map with the recreation zones indicated. In another aspect, receiving ratings from a plurality of users; and sending recommendations to a display on the price for rental of at least one of the recreation zones based on the ratings received from a plurality of users.

### BRIEF DESCRIPTION OF THE DRAWINGS

FIG. 1 is a schematic block diagram providing an overview of a system according to an embodiment of the present invention;

FIG. 2 is a schematic block diagram providing a view of the facility optimizer system;

FIG. 3A is a front view of a facility provider data entry template;

FIG. 3B is a front view of a user reservation template;

FIG. 4 is a screen shot of an example of a reservation confirmation with an accompanying map output by the facility optimizer;

FIG. 5 is a flowchart of an example of an entry process for a facility provider;

FIG. 6 is a flowchart of a user reservation process according to an embodiment of the invention; and

FIG. 7 is an example of a proof of insurance that may be used in accordance with an embodiment of the invention.

### DETAILED DESCRIPTION

### I. Definitions, Acronyms and Cross-References

The following terms and acronyms are explained below and are used throughout the detailed description:

Associated Customer. An associated customer may be defined as someone who has an established relationship with a facility or institution that owns a facility and a high priority access to the facility. Examples of the type of users in the associated customer list could include the students, coaches, faculty or alumnae of a university. Associated Customers may be given the highest priority access to a facility.

Blog. Any system that supports an online diary published on a web page or a shared on-line journal where people can post diary entries about their personal thoughts and hobbies.

Chat Room. Any system that allows any number of users to have a typed and/or voice-based, real-time, on-line conversation, either by all users logging into the same computer, or more commonly, via a network. Using special software, Internet users can enter chat areas or “virtual spaces” where they can communicate in real time.

Client-Server. A model of interaction in a distributed system in which a program at one site sends a request to a program at another site and waits for a response. The requesting program is called the “client”, and the program that responds to the request is called the “server”. In the context of the World Wide Web, the client is typically a “Web browser” that runs on a user's computer; the program that responds to Web browser requests at a Web site is commonly referred to as a “Web server”.

Database. One or more large structured sets of persistent data maintained upon a computer system organized and structured according to a software system defining rules for organization as well as responding to queries to read, write, or modify data as well as provide statistical information regarding the contained data. As used in this application, a database may be either a single unified system or a distributed system wherein certain database elements are located upon different systems or servers which may be in different physical locations, acting in harmony to appear as one unified database.

Extensible Markup Language (XML). XML describes a class of data objects known as XML documents and partially describes the behavior of computer programs which process these documents. More specifically, XML is a restricted form of the Standard Generalized Markup Language (also known as SGML). XML documents are made up of storage units defined as entities which in turn comprise either parsed or unparsed data in the form of characters or simply a character. XML is designed and intended to improve the functionality of the Internet by providing more flexible and adaptive forms of information. XML can be used to store any kind of structured information and in such encapsulated form, pass it between different computer systems which would otherwise be unable to communicate.

Hypertext Markup Language (HTML). A standard coding convention and set of codes for attaching presentation and linking attributes to informational content within documents. During a document authoring stage, the HTML codes (referred to as “tags”) are embedded within the informational content of the document. When the Web document (or “HTML document”) is subsequently transferred from a Web server to a Web browser, the codes are interpreted by the Web browser and used to parse and display the document. In addition to specifying how the Web browser is to display the document, HTML tags can be used to create links to other Web sites and other Web documents (commonly referred to as “hyperlinks”).

Hypertext Transport Protocol (HTTP). The standard World Wide Web client-server protocol used for the exchange of information (such as HTML documents and client requests for such documents) between a Web browser and a Web server. HTTP includes a number of different types of messages that can be sent from the client to the server to request different types of server actions.

HTTPS. HTTP over SSL (Secure Sockets Layer) can be best understood as a secure form of HTTP communication. Specifically, SSL is a protocol utilized for the authentication and encryption of HTTP traffic. In operation, the server and client exchange a set of encryption keys that are used to create a unique encryption key used to encrypt all data exchanged during the session.

Instant Messaging. Abbreviated “IM”, a type of communications service that enables one to create a private chat room with another individual in order to communicate in real time over the Internet. IM is analogous to a telephone conversation but using text-based, not voice-based, communication. Typically, the instant messaging system alerts you whenever somebody on your private list is online. You can then initiate a chat session with that particular individual.

Insurance. A promise of compensation for specific potential future losses in exchange for a periodic payment. An insurance policy is the actual document that sets forth information such as coverages, terms, conditions, and exclusions that was purchased. A Certificate of Insurance (also known as an Insurance Certificate) may be used to provide proof to a third party that the person or organization has insurance. A Certificate may also be used to add a third party onto the policy as an “additional insured”.

Insurance Binder. A temporary issuance of proof of insurance that will “bind” or cover a party or organization until a formal policy is issued. The insurance binder may include information such as name of the insured, the limits of the coverage in dollar amounts, what type of insurance it is, what is actually being covered, specific areas that may not be covered, the company issuing the insurance, beginning coverage date, and ending coverage date.

Internet. A collection of interconnected (public and/or private) networks that are linked together by a set of standard protocols to form a distributed network. While this term is intended to refer to what is now commonly known as the Internet, it is also intended to encompass variations that may be made in the future, including changes and additions to existing standard protocols.

LAN. A Local Area Network of computer systems, typically within a building or office, permitting networking, the associated sharing of resources and files, such as application software, printers, and client information, in an inter-office setting.

Non-Associated Customer. A Non-Associated Customer is one who is not an Associated Customer or Preferred Customer but who still wants to use a facility or a plurality of facilities. They could be registered users or anyone who visits the facility optimizer online website as discussed herein. An example would be someone who is in the same community as a university but does not attend and would like to reserve the tennis courts. The Non-Associated Customers may be given the lowest level of priority access to the facility compared to the Associated Customers and Preferred Customers.

Preferred Customer. May include, but not be limited to, residents of a county or city or predetermined region; customers willing to pay a membership fee to use a facility; customers who have specifically requested to be notified in advance when a facility is available; larger customers; and/or customers who are frequent users. The preferred customers may be given a mid-level priority to a facility (as opposed to an Associated Customer who may receive a highest level priority and a Non-Associated Customer that would receive a lowest level priority).

Short Message Service (SMS). A service available on most digital mobile phones (and other mobile devices, e.g., a Windows Mobile Device, or occasionally even desktop computers) that permit the sending of short messages (also known as text messages or texts) between mobile phones, other mobile devices and even landline telephones. Messages are sent via a store-and-forward mechanism to a Short Message Service Center (SMSC), which will send the message to the recipient.

Social Network. A group of friends that may connect through a website(s) or peer-to-peer network and is established to allow end users to communicate directly with each other on topics of mutual interest. The friends might describe themselves in a detailed profile, specify friends, find friends' friends, browse profiles, invite their friends to join, messaging and communications, create groups and identify others of interest.

Speech Recognition System. Also known as automatic speech recognition or computer speech recognition and which converts spoken words to text. The term “voice recognition” is sometimes used to refer to recognition systems that must be trained to a particular speaker—as is the case for most desktop recognition software.

Structured Query Language (SQL). SQL is a standard language used to communicate with relational database management systems (such as Oracle, Sybase, Microsoft SQL Server, Access, etc.) for the purpose of performing tasks such as data insertion, deletion, update, and general query for the return of data.

Uniform Resource Locator (URL). A unique address which specifies the location of a file or other resource on the Internet.

V CAST. V CAST is a third generation International Mobile Telecommunications-2000 Evolution-Data Optimized (“3G EV-DO”) network created which is designed to deliver audio, video, and entertainment content in a broadband format.

Web Server. The computer that helps to deliver content that can be accessed through the Internet. The web server can be hardware, a software computer application that is installed on a computer(s) or a combination of hardware and software.

World Wide Web (“Web”). Used herein to refer generally to both (1) a distributed collection of interlinked, user-viewable hypertext documents (commonly referred to as “Web documents”, “Web pages”, “electronic pages” or “home pages”) that are accessible via the Internet, and (2) the client and server software components that provide user access to such documents using standardized Internet protocols. Currently, the primary standard protocol for allowing applications to locate and acquire Web documents is the Hypertext Transfer Protocol (HTTP), and the electronic pages are encoded using the Hypertext Markup Language (HTML). However, the terms “World Wide Web” and “Web” are intended to encompass future markup languages and transport protocols that may be used in place of or in addition to the Hypertext Markup Language (HTML) and the Hypertext Transfer Protocol (HTTP).

### II. Terms

The terms “a”, “an” and “the” mean “one or more”, unless expressly specified otherwise.

The terms “embodiment”, “embodiments”, “an embodiment”,“the embodiment”, “the embodiments”, “one or more embodiments”, “some embodiments”, “certain embodiments”, “one embodiment”, “another embodiment” and the like mean “one or more (but not all) exemplary embodiments of the disclosure”, unless expressly specified otherwise. A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The term “plurality” means “two or more”, unless expressly specified otherwise.

The term “herein” means in the present application, including anything which may be incorporated by reference, unless expressly specified otherwise.

The phrase “at least one of”, when such phrase modifies a plurality of things (such as an enumerated list of things) means any combination of one or more of those things, unless expressly specified otherwise.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, . . . 9) and non-whole numbers (e.g., 1.1, 1.2, . . . 1.9).

### III. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. The term “determining” does not imply certainty or absolute precision, and therefore “determining” can include estimating, extrapolating, predicting, guessing and the like. The term “determining” does not imply that mathematical processing must be performed, and does not imply that numerical methods must be used, and does not imply that an algorithm or process is used.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology are Not Limiting

Neither the Title (set forth at the beginning of the first page of the present application) nor the Abstract (set forth at the end of the present application) is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. Although particular aspects or features of the disclosure may be described with reference to one or more particular embodiments and/or drawings, it should be understood that such features are not limited to usage in the one or more particular embodiments or drawings with reference to which they are described, unless expressly specified otherwise.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for long period of time (e.g. weeks at a time). In addition, devices that are in communication with or coupled with each other may communicate directly or indirectly through one or more intermediaries.

Although process (or method) steps may be described or claimed in a particular sequential order, such processes may be configured to work in different orders. In other words, any sequence or order of steps that may be explicitly described or claimed does not necessarily indicate a requirement that the steps be performed in that order unless specifically indicated. Further, some steps may be performed simultaneously despite being described or implied as occurring non-simultaneously (e.g., because one step is described after the other step) unless specifically indicated. Moreover, the illustration of a process by its depiction in a drawing does not imply that the illustrated process is exclusive of other variations and modifications thereto, does not imply that the illustrated process or any of its steps are necessary to the embodiment(s), and does not imply that the illustrated process is preferred.

### VI. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more microprocessors, central processing units (CPUs), computing devices, controllers, microcontrollers, digital signal processors, or like devices or any combination thereof, regardless of the architecture (e.g., chip-level multiprocessing/multi-core, Reduced Instruction Set Computer (RISC), Complex Instruction Set Computer (CISC), Microprocessor without Interlocked Pipeline Stages, pipelining configuration, or simultaneous multithreading).

Further, programs that implement methods described herein may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only to implement the embodiments.

The term “computer readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media may include, for example, optical or magnetic disks and other persistent memory. Volatile media may include dynamic random access memory (DRAM), which typically constitutes the main memory. Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a Random Access Memory (RAM), a programmable read only memory (PROM), an erasable programmable read only memory (EPROM), a flash electrically erasable programmable read only memory (FLASH-EEPROM), any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), Bluetooth, and Transmission Control Protocol/Internet Protocol (“TCP/IP”), Time Division Multiple Access (TDMA), Code Division Multiple Access (CDMA), and 3G; and/or (iv) encrypted to ensure privacy or prevent fraud in any of a variety of ways well known in the art.

Thus in some embodiments a description of a process may be a description of a computer-readable medium storing a program for performing the process. The computer readable medium may store (in any appropriate format) those program elements which are appropriate to perform the method.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. The database formats may include relational databases, object-based models and/or distributed databases which could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, Wide Area Network (“WAN”) or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino® processor, that are adapted to communicate with the computer. Any number and type of devices may be in communication with the computer.

In an embodiment, a server computer or centralized authority may not be necessary or desirable. For example, an embodiment may be practiced on one or more devices without a central authority. In such an embodiment, any functions described herein as performed by the server computer or data described as stored on the server computer may instead be performed by or stored on one or more such devices.

Where a process is described in an embodiment the process may operate without any user intervention.

### VII. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

### VIII. Description of Embodiments

Many facility and institutions, both private and public, have excess capacity which is not being fully utilized. The excess capacity system 100 as described herein will help institutions and communities obtain a more optimal usage of at least one and/or a plurality of recreation zones in their facilities. A private institution shall be defined in this Description as one that is closed to the general public and requires some type of admissions process such as a school, university or private health club. A public institution shall be defined in this Description as one that is open to the general public (although may or may not require a fee) such as a town park or public club.

Oftentimes at least one obstacle for using these private and public facilities is that users for particular activities are not covered by the insurance of the private or public institution. Also, another obstacle is that insiders who are allowed to use the facility do not have the proper type of insurance coverage necessary to cover a particular activity. Therefore, as described in some of the embodiments herein these obstacles may be overcome by either determining in advance that the potential user of the facility either has the proper insurance or to provide the potential user with the necessary insurance.

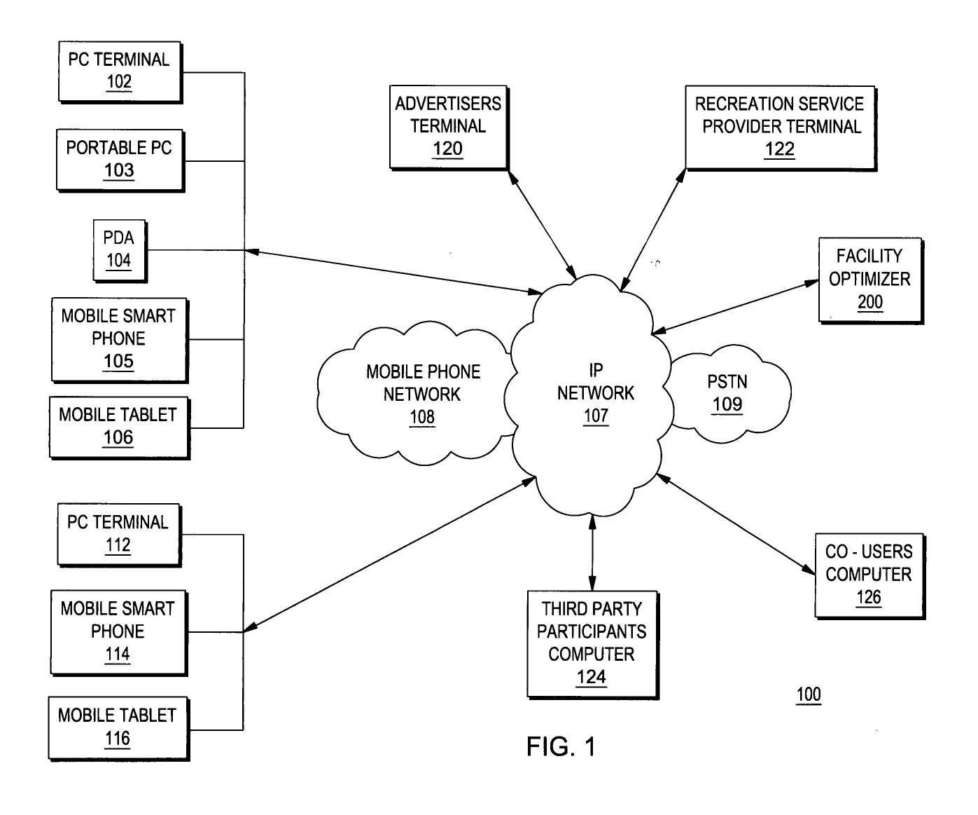

FIG. 1 is a general diagram of an implementation of one exemplary embodiment of the excess capacity system 100 that provides the ability for at least one manager or a plurality of managers of a facility to optimize the use of the recreation zones contained therein. The list of types of facilities that may participate in this system may include, but are not limited to, baseball fields, turf fields, tennis courts, gymnasium space, practice studios, ice rinks, soccer fields, lacrosse fields, football fields, baseball fields, pavilions, cricket pitches, picnic sites, meeting spaces, birthday party sites, campsites, sports clubs, school systems, field hockey, lacrosse, training facility, performance venues, and national or regional parks.

A plurality of personal computer (“pc”) terminals or mobile wireless communication devices (“mobile devices”) 102-106 as shown in FIG. 1 are operated by individual users, customers or member of a recreation (or sports) league who may connect through an Internet Protocol (“IP”) network 107 such as the Internet, Intranet or another communication system to a facility optimizer system (“facility optimizer”) 200 located in the excess capacity system 100. The terms “user”, “customer” or “member” will be used interchangeably throughout this Description to indicate someone or some group such as a recreation league who wish to reserve the excess capacity associated with a facility or institution. The “facility provider” will be used throughout this Description to indicate someone or group of people associated with a facility such as a facility manager who wish to offer the facility for use. Although only five pc and mobile devices 102-106 are shown in FIG. 1 it is to be understand that the facility optimizer 200 may be scaled up to support hundreds of thousands or even millions of pc and mobile devices. In a first embodiment, the facility optimizer 200 may be configured to support one facility offering one or only a few recreation zones designed for users in the range of approximately 10 to 100 users. In a second embodiment, the facility optimizer 200 may be configured to serve a larger facility or a plurality of facilities with a plurality of recreation zones designed for users numbering in the approximate range of 100 to 5,000 users. In a third embodiment, the facility optimizer 200 may be significantly scaled up to configured to serve a plurality of facilities each with a plurality of recreation zones and designed to service users numbering greater than 100,000 and greater than a million of users through either stationary or mobile devices. In an illustrative embodiment, the IP Network 107 can be accessible to users operating a wide variety of pc terminals or mobile devices 102-106. These devices may be stationary such as a personal computer terminal 102 or mobile such as a portable PC device 103, a Personal Digital Assistant (“PDA”) 104, a mobile smartphone 105 such as an iPhone®, or a portable wireless tablet 106 such as an iPad®. The mobile communication devices 103-106 may operate using a variety of operating systems, including, for example, Series 60 (Symbian®), Windows Mobile® for Smartphones, Apple® iOS4, Android® Operating System (OS), and Palm® OS. The terminals and devices 102-106 may have a voice entry function through a speaker-receiver or by use of the standard SMS lexicon and syntax, and it may be adaptive to individual users' voice commands and usage patterns that are stored on and accessed from a mobile subscriber characteristics database. The voice entry function may permit voice dialing, voice memo, voice recognition, speech recognition, or other functions related to audible input. In one embodiment, the facility optimizer 200 may be responsive to voice activated commands and can perform the same functions as with text entry. In an alternative embodiment, items 102-106 may be High Definition (HD) viewing enabled, three dimensional (3-D) viewing enabled or 3-D HD viewing enabled so that the user may watch videos or view the website of the facility optimizer 200 in HD, 3-D or 3-D HD. For example, the facility optimizer 200 may be configured to broadcast HD, 3-D or 3-D HD webcasts of sports activities that are filmed in the recreation zones and are downloaded to the facility optimizer 200.

In an illustrative embodiment, the IP network 107 may be accessible to at least one pc terminal 102 or one or more mobile communication devices 103-106 via one or more mobile phone networks 108 and/or a public switched telephone networks (PSTN) 109. The IP Network 107 may then be connected to the facility optimizer 200 which may be located on at least one webserver at a central location, on a plurality of webservers with functionalities spread over servers at a central location, and/or functionality incrementally distributed in a computing “cloud” over a plurality of webservers at a plurality of locations. In other alternative embodiments of a much smaller scale implementation, the facility optimizer 200 may be located on a pc terminal or on a mobile communication device.

The facility optimizer 200 is designed to handle a wide variety of facility providers of both public institutions and private institutions. The plurality of facility providers which utilize the facility optimizer 200 to handle excess capacity of recreation zones may be either affiliated facility providers or unaffiliated facility providers. Affiliated facility providers may be characterized as being all under the same umbrella organization and an example may be all the parks in a single community. Unaffiliated facility providers would be institutions that do not have a significant relationship with each other and do not cooperate in the use of facilities. An example of unaffiliated facility providers would be two separate universities that may be located in the same community but do not interact when reserving each other's facilities. One of the benefits of the excess capacity system 100 described herein would be to provide a website which can handle the excess capacity of a plurality of substantially unaffiliated facility providers in an efficient manner. Examples of devices that facility providers may use to interact with the facility optimizer 200 include a pc terminal 112, a mobile smartphone 114 such as an iPhone® or a portable wireless tablet 116 such as an iPad® or other similar devices which may be connected through an IP Network 107 to the facility optimizer 200. Only three facility provider devices are shown in FIG. 1 in connection with the facility optimizer 200 and they all may be used to manage the use of just one facility. However, the number of facility provider devices which may be serviced may be scaled up as the facility optimizer 200 is configured to handle between one and 100 facilities, over 500 facilities, over 1,000 facilities or scaled up more significantly to service over 100,000 facility provider devices. In an alternative embodiment, the excess capacity system 100 may be configured to cover a national network capable of handling at least 500,000 facilities or institutions which may be located across the nation.

The IP Network 107 is also accessible to a plurality of additional computers and servers such as an advertiser's terminal 120 (which may also be a mobile device), a recreation service provider's terminal 122 (which may also be a mobile device), third party participant computers 124 (which may also be a mobile device), and co-users computer 126 (which may also be a mobile device) which can use it to communicate with the facility optimizer 200. The function of these additional terminals and/or mobile devices will be explained below in more detail.

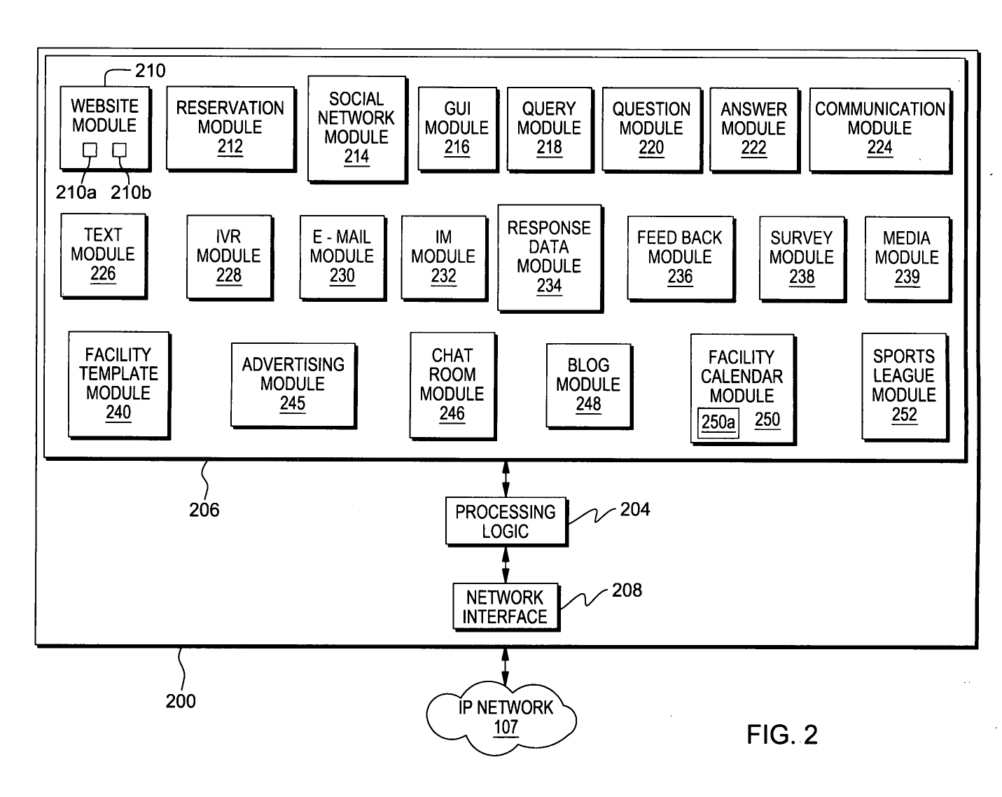

FIG. 2 is a detailed view of the facility optimizer 200. The facility optimizer system 200 is adapted to provide an online website offering facility reservation services and other services and products via the IP network 107. The facility optimizer system 200 may include one or more ports, slots, or similar capabilities to accommodate expansion cards, such as a MultiMediaCard (MMC), a MMC/Secure Digital (SD), a Reduce Size Multimedia Card (RS-MMC) 3v, an RS-MMC 1.8v/MMC mobile, a Universal Serial Bus(USB)-based memory device, and/or a Memory Stick Duo. In another embodiment, the facility optimizer 200 may also accommodate high-speed data communications by utilizing General Packet Radio Service (GPRS), Enhanced GPRS (EGPRS/EDGE), Wideband Code Division Multiple Access (WCDMA), Integrated Dispatch Enhanced Network (iDEN) protocols or the like. Additional features of the facility optimizer system 200 may include any or all of the following: a hard drive, Global Positioning System (GPS) location capability, AM/FM radio or stored music to stream content from the website, infrared technology, an integrated PDA, Java Platform Micro Edition (Java ME), MultiMedia Messaging Service, predictive text entry, synchronization markup language (SyncML), text keyboard, text messaging, text messaging templates, touch screen, USB ports, high frequency wireless local access network (WiFi) technology, and wireless Internet. Further, in an illustrated embodiment the facility optimizer 200 may transmit and/or receive data to/from the IP Network 107 wirelessly by utilizing an internal antenna, a stub antenna, a patch antenna, an antenna array, a stub/extendible antenna, or an extendible antenna.

In an illustrative embodiment, the facility optimizer 200 may include processing logic 204 and memory 206 that is accessible to the processing logic 204, such as memory devices at one or more servers of the facility optimizer 200. The processing logic 204 and memory 206 may function as a web server to support an HTTP that handles requests for records, documents, and other services and transmits such information through a network interface 208 to the IP Network 107. The webserver may utilize software programs such as MySQL, Apache or Microsoft Internet Information Server. Alternatively, the facility optimizer 200 may include a plurality of web servers that independently or redundantly include logic and memory adapted to provide one or more functions with respect to fulfilling electronic Internet-based transactions. The network interface 208 may facilitate communication between the facility optimizer system 200 and the IP network 107. The network interface may include, but not be limited to, a modem, network interface card, network adapter, network interface controller (NIC), LAN adapter or the like.

The memory 206 may include a plurality of modules 210-252 that are adapted to provide various functions of the facility optimizer system 200 with respect to reservation and a plurality of other services. The modules 210-252 can include processor-readable or computer readable instructions that are executable by the processing logic 204, such as instructions included in one or more applications, operating systems, or other computer programs. In other embodiments, the modules 210-252 may include any combination of instructions and hardware logic. The modules 210-252 can be distributed independently or redundantly among memory at one or more servers of the facility optimizer system 200 located at one location or at a plurality of locations.

The memory 206 includes a website module 210 that is executable by the processing logic 204 to provide an online facility optimizer website (“online website”) 210a via the IP network 107. The online website 210a offers an electronic view of services, products, or other offerings as discussed below. The online website 210a may be a standalone website. A link may be used on the website of a facility provider to direct a potential user of an offered facility to the online website 210a of the facility optimizer 200. In an alternative embodiment, an online website 210b may be a section or portion of the website of an instituion (e.g., a plug in) or even a webpage of the institution that utilizes the reservation services of the facility optimizer 200. The webpage may be branded with the logo of the facility or institution. The website module 210 is executable by the processing logic 204 to provide a search process via the online website 210a, which allows users or customers to search the data stored, for example, by the reservation module 212 and which returns one or more search results in response to a query by the user. The memory 206 may include a social network database 214 to store social network information associated with users or customers that are registered with the online website 210a. For example, when a user or customer registers with the online website 210a, the website module 210 is executable by the processing logic 204 to prompt the user or customer for contact information. Further the website module 210 may prompt the user or customer for contact information associated with interested parties (which may be contacted through third party participant computers 124 and/or co-users computers 126 as shown in FIG. 1) such as one or more members of a sports league or social network that are associated with the user or customer and shall participate with the user in the use of the reserved facility so that these interested parties may be updated on the status of a facility reservation. Alternatively, the interested parties might not be actual participants but just want to follow the activities on the recreation zones of the facility such as relatives, coaches, other students or the like. Such interested party contact information may include names or other user identifications, e-mail addresses, Facebook® identification, telephone numbers, mobile telephone numbers, IP addresses, other contact information, or any combination thereof. The website module 210 is executable by the processor logic 204 to receive contact information that is entered by users or customers via terminals or devices such as 102-108 (see FIG. 1). The user may also port in contact information from an address book or other contact list of the user, from an online social networking site such as Facebook® or LinkedIn® or other additional sites provided by the IP network 106 or any combination thereof. The social network database 214 can store one or more social networks associated with a user or customer. The social network database 214 can also store a one or a plurality of communications preferences of one or more members of a user's social network.

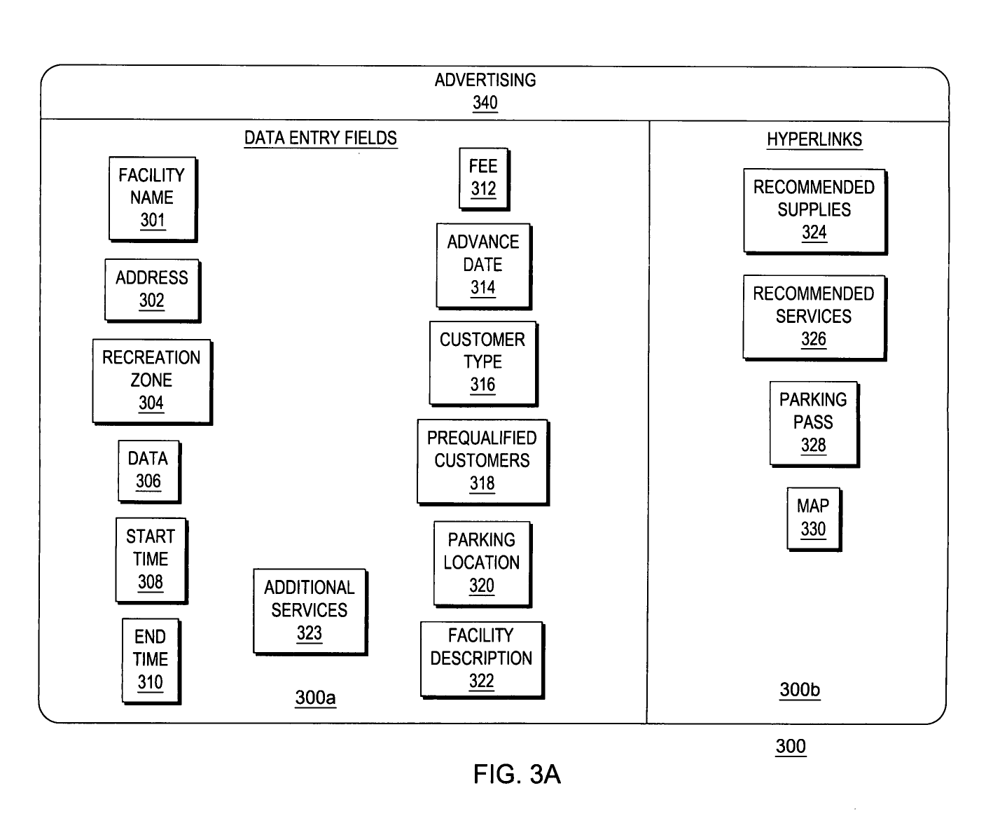

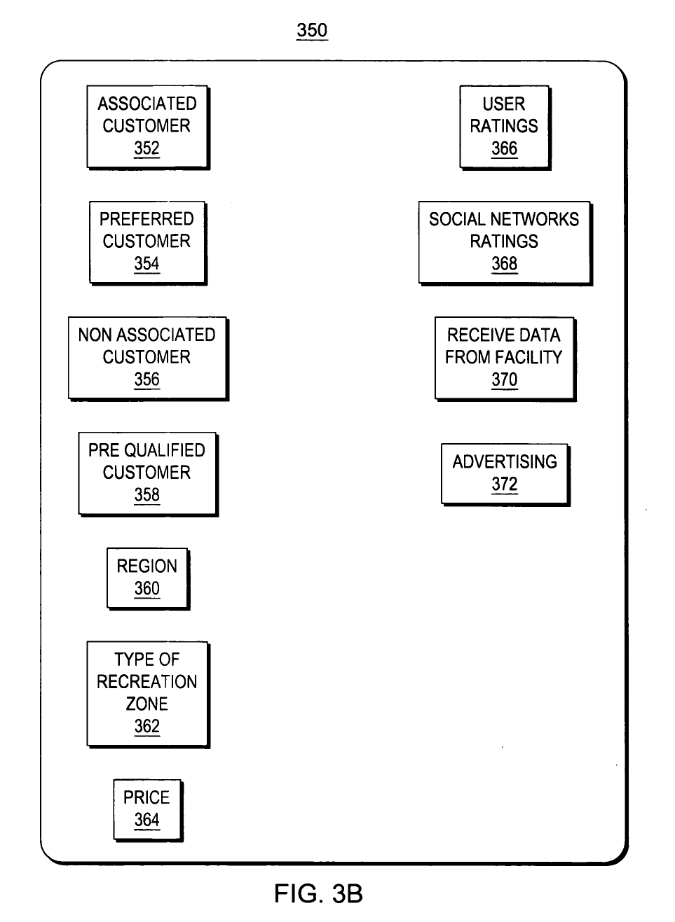

Further, the memory 206 may include a graphical user interface (GUI) module 216 that is executable by the processing logic 204 to provide various graphical user interfaces including interactive graphical elements via the website module 210. For example, the GUI module 216 can be executable by the processing logic 204 to provide the facility provider data entry template (“facility provider template”) 300 as shown in FIG. 3A via the online website 210a in response to a request through the website 210a of a facility provider. The GUI module 216 is executable by the processing logic 204 to include with the facility provider template 300 various advertising of services or products 340 from the advertising module 245 which is targeted at the facility provider. Information entered by a facility manager regarding the recreation zones in a facility may be saved in the facility template module 240 as discussed below. The GUI module 216 is also executable by the processing logic 204 to provide a user facility reservation template (“user reservation template”) 350 as shown in FIG. 3B by which a user may execute a search for at least one or a plurality of recreation zones within a facility or plurality of facilities. The user reservation template 350 may allow for queries by type of customer (whether associated customer 352, preferred customer 354, and/or non-associated customer 356 as discussed in detail below), whether customer is prequalified 358, region 360 (by city, state, zip code or the like), type of recreation zone 362 (such as tennis court, baseball field or the like), price 364, user ratings 366, social network ratings 368 or the like. The user reservation template 350 may also be configured to display advertising 372 to the user while the user completes the search query. The user reservation template 350 may be configured to only display data entry blanks for searches that the user is permitted to use depending on whether the user is a predetermined type of customer (e.g., associated customer, preferred customer, or non-associated customer) or whether the user is a prequalified customer (also discussed below). Similarly, the search results displayed on the online website 210a may be determined by the type of customer or whether the user is a prequalified customer. In a particular embodiment, the GUI module 216 is executable by the processing logic 204 to include with a user reservation template 350 a selectable indicator 370 of an option to receive data related to the facility or services and products from the facility provider or the operator of the facility optimizer 200. In response to a selection of the indicator, the query module 218 is executable by the processing logic 204 to query a survey database 238 to retrieve data corresponding to one or more facilities and their ratings, services or products being viewed by a user and display to the user via the online website 210a. Alternatively, the communication module 224 is executable by the processing logic 204 to construct a communication—whether text or voice—in response by a request by a user and to send the communication to the users or other interested parties by email or Facebook® posting or the like determined by the user such as other users, participants, members of a social network, parents, and/or coaches. As discussed below, the text module 226, the IVR module 228, the e-mail module 230, and the IM module 232 may be executable by the processing logic 204 to send communications to a user or other predetermined interested parties to their computer, phone, or any combination thereof, according to communications preferences associated with each user and/or predetermined interested parties.

The memory 206 may include a query module 218 that is executable by the processing logic 204 to query the social network database 214 to retrieve contact information, communication preferences, other data, or any combination thereof, related to members of one or more social networks of the customer or other user determined interested parties. In one embodiment, the GUI module 216 is executable by the processing logic 204 to output a list of selectable members of one or more social networks associated with the customer and to receive selections of one or more members to whom a communication regarding the facility reservation made by a user is to be sent.

In an illustrated embodiment, the memory 206 includes a question module 220 that is executable by the processing logic 204 to receive a question from the customer that is to be sent with a communication to the facility provider or to the facility optimizer 200. The query module 218 is executable by the processing logic 204 to query an answer database 222 to determine whether the facility provider or facility optimizer 200 has previously answered a similar question. If the question has been answered, the GUI module 216 is executable by the processing logic to output the previous answer via the online website 210a or send a communication through the communication module 224 to the customer. This answer might occur automatically and, at the facility provider's instructions, might not require even notification to the facility manager.

In an alternative embodiment, the question module 220 may be configured to prompt the user for a question to be submitted to other users of the facility optimizer 200 or member(s) of a sports league or social network to whom a question regarding a particular recreation zone or facility may be sent. The answer database 222 may then store answers received back from such other users or members. As discussed above, when a question is received from the user in this manner, the question module 220 is executable by the processing logic 204 to determine whether the answer database 242 stores an answer to that question from one or more of the customers or social network members. Previously stored answers can then be displayed via the online website 210a or responded to by a communication from the communication module 224 by email, text, Facebook® posting or the like.

The communication module 224 is also executable by the processing logic 204 to send a communication to a plurality of interested parties such as fellow participants regarding the reservation and updates effecting that reservation. The reservation communication may be sent to other users or customers of the online website and/or sent to one or more members of a sports league or social network(s) of the user, while observing communications preferences of one or more of the interested parties such as users, participants, and/or members. The communication may be text or voice. Such a communication might include updates on the status of the reservation, carpooling information, cancellation information, rescheduling information, or the like. In an illustrative embodiment, the communication module 224 is executable by the processing logic 204 to construct a communication that includes selectable indicators or response options which may be in the form of a hyperlink. In one embodiment, a question submitted by the user or customer requesting a response (such as an RSVP) can be included in a communication. The communication module 224 or the question module 220 can be executable by the processing logic 204 to tag the communication, such that an answer to the question can be associated with the answering interested party and stored at the answer module 222 for future use. In an alternative embodiment, the communication module or another predetermined section of memory may update a Facebook® page to communicate with a plurality of interested parties regarding the reservation or services offered by a facility or facilities.

The memory 206 may also utilize the text module 226 that is executable by the processing logic 204 to send communications to a plurality of fellow interested parties regarding the reservation of a recreation zone in a facility through their phones via short messaging service (SMS) or other text messaging service. Alternatively, the text module 226 might be configured to update a Facebook® or other social networking page with details or status of a reservation. Further, the memory 206 may include an interactive voice response (IVR) module 228 that is executable by the processing logic 204 to receive or send interactive voice communications to and from fellow interested parties' phones or other devices. The IVR module 228 may also be used by facility providers or users when interacting with the facility optimizer 200. For example, the facility provider may create or update a facility record through voice interaction. Also, a user might make a reservation through voice interaction with the facility optimizer 200. In addition, the IVR module 228 may be used to update a Facebook® or other social networking webpage with a voice recording on the details or status of a reservation.

In addition, the memory 206 may include an e-mail module 230 that is executable by the processing logic 204 to send communications to plurality of participants' phones or other devices in reserving or confirming a recreation zone in a facility via electronic mail. Moreover, the memory 206 may include an instant messaging (IM) module 232 that is executable by the processing logic 204 to send communications to a plurality of other participants in reserving a recreation zone in a facility via an IM service. Alternatively, the e-mail module 230 and IM module 232 may be used to update a Facebook® or social networking webpage on the details or status of a reservation. In other embodiments, the facility optimizer system 200 can be adapted to send communications to interested parties via the PSTN 109.

The memory 206 may include a response data module 234 that is executable by the processing logic 204 to receive responsive data from other user, interested parties, or a member of a sports league or a social network to whom a communication has been sent. The GUI module 216 is executable by the processing logic 204 to output the responsive data via a GUI of the online website 210. In a particular embodiment, the memory 206 may include a feedback module 236 that is executable by the processing logic 204 to receive ratings from a user, interested party or a member of a social network. These ratings may be displayed at the online website 210a or distributed to users or interested parties. For example, the ratings can indicate a level of trust associated with a facility or facility provider with regard to quality or service of a facility or recreation zone in the facility. In another example, the feedback module 236 is executable by the processing logic 204 to determine a rating associated with a facility or facility provider based on a plurality and/or quality of inputs from users or customers over time. Such inputs may address a plurality of criteria including whether a facility (or at least one recreation zone in the facility) was well organized, clean, the view offered by the facility, the overall attractiveness of the facility, and/or whether the services that may be offered by the facility provider were as expected. Ratings can be stored in association with customer data at, for example, the social network database 214.

The survey module 238 that is executable by the processing logic 204 may be used to send survey questions to each user of the online website 210a or a member of a social network of a customer or other registered visitor of the online site. The survey module 238 is executable by the processing logic 204 to send a communication asking whether the recipient had a favorable view of a facility, recreation zone, service, or other offering. The survey module 238 is executable by the processing logic 204 to collect survey results and output the survey results to a user via the online website 210a or by email.

In another embodiment, the memory 206 may include a media module 239 that is executable by the processing logic 204 to store and display on the online website 210a or to provide download capability which may include pictures, video and/or audio. For example, videos or pictures of activities conducted on the plurality of recreation zones offered by the facility providers may be stored here. These videos or pictures may be public to any visitors to the online website 210a or, alternatively kept behind an electronic security wall. These videos may be in HD format and/or in a format to allow for V CAST streaming to broadband devices such as mobile smartphones. If the videos and/or pictures are kept secured, they might only be available to those with a password, those visitors that are members of the same sports league or social network as the user who stored the videos and/or pictures, certain types of internet address (e.g., with .edu at the end of the email address) or only to certain types of predetermined customers of the facility optimizer 200. In certain embodiments, these types of customers may be divided based on whether they are associated customers, preferred customers, or non-associated customers or may be divided depending on whether their institutions (such as schools) or facilities are affiliated or not affiliated with each other. These videos and/or pictures may be retrieved by users or interested parties through links provided at the online website 210a or through email links which are distributed by users to other users, interested parties, friends or members of a social network.

In an alternative embodiment, the facility optimizer 200 may be configured to stream the downloadable media in a live or delayed format so that users can watch the contests at the online website 210a or download the video to another site. In an alternative embodiment, the video may be streamed to judges who may make rulings on issues that may arise in a sporting contest on one of the recreation zones. In another alternative embodiment, the videos may be searchable by a third party (on a third party participant computer 124 as shown in FIG. 1) who wishes to review the content of the stored videos. For example, an interested party such as a sports coach might want to review the videos of a sports contest to determine the quality of the players. In another embodiment, the videos may be searched by the interested party using facial recognition software to identify players that the interested party wants to view (“facial recognition search”). Facial recognition software may be used that is provided by companies such as Adobe®, Google® (Neven Vision), L1 Identity Solutions®, Samsung®, or Sony®. In an alternative embodiment, the facial recognition search may have 3-D facial recognition capability as provided by companies such as Technest® or L-1 Identity Solutions®. In another alternative embodiment, the facial recognition search may be supplemented with a skin texture analysis to provide a more accurate search from companies such as Google®. In one embodiment, the facial recognition software and/or skin texture analysis might match the players with background information from a player database and store the background information with the video. The video may then be automatically edited (or, in an alternative embodiment, manually operator edited) by the facility optimizer 200 to display or tag background information on the players while they are performing in the video. This edited video may also then be text searchable by an interested party such as a coach. In an alternative embodiment, the facial recognition software might also be supplemented with software that can measure a plurality of attributes of the participants in the videos. For example, a first attribute measured could be to determine how fast a player can cover a certain distance of ground (e.g., how fast the player can run 40 yards) and store this attribute with the player's background information and subsequently displayed on an edited video. A second attribute that might be measure is the size of the player which also might be stored in the player's background information and also subsequently displayed on an edited video.

The videos and/or pictures may be categorized in the media module 239 to allow for optimal searching. For example, the videos and/or pictures may be organized by date, region, level of play, and/or team names. In another embodiment, the facility optimizer may be configured to allow interested parties such as coaches to search through unlimited videos and/or pictures looking for potential recruits by date, region, level of play or team names. In an alternative embodiment, the facility optimizer 200 is configured to store and retrieve games or practices filmed in high definition and/or high resolution (such as satellite high resolution using GPS) with play back from the media module 239 on the online website 210a. In an alternative embodiment, the facility optimizer 200 may be configured to offer video conferencing through the online website 210a for meetings between customers and facility providers and/or users with other users.

In another embodiment, in addition to features already discussed above, the videos in the media module 239 may be stored in augmented reality whereby the videos have been supplemented by graphics with personal information regarding the user and/or the participants and displayed in script, a box or the like somewhere in the video display. For example, social networking webpage information of a user and/or participant in the video might be added to a display screen with the video by the facility optimizer 200. The social networking webpage information may be added based on information obtained from the facial recognition software. Software from Layar® may be one manner in part to implement these augmented reality features onto the stored videos in the media module 239.

The video in the media module 239 may be stored in three dimensional (3-D) video and/or 3-D HD video and made available as a 3-D and/or 3-D HD webcast to users of the facility optimizer. The 3-D video may be implemented according to the Motion Picture Experts Group 4 (“MPEG4”) standard utilizing technology provided by companies such as Yellowbird® or Sensio®. As discussed above, the media module 239 may store multiple videos (optionally, in 3-D) of the same contest on a recreation zone which are downloaded to the facility optimizer 200 from a plurality of devices and then offered up to users by the facility optimizer 200. These videos may allow the viewer to see either a plurality of videos of the same contest or plurality of videos combined but offering different viewpoints of the same contest. The facility optimizer 200 may be configured to automatically edit and synchronize a plurality of videos stored in the media module 239 to produce a substantially fluid sequence of events that transpired on the plurality of recreation zones or just the highlights. In addition, the facility optimizer 200 may add augmented reality graphics to the plurality of videos received. The facility optimizer 200 may be configured to automatically send either one or all of a plurality of collected videos of a contest that has taken place on at least one or a plurality of recreation zones to one or a plurality of addresses as designated by a user of the online website 210a such as fellow users, interested parties, members of a social network, or the like.

The facility optimizer system 200 may also contain a chat room module 246 to host a chatroom on the website. The facility optimizer system 200 may also contain a blog module 248 to host a blog. The chatrooms and blogs may be unified or divided up into a plurality of sections dedicated, for example, to a designated facility or sports league. The chat room module 246 or blog module 248 may be used to chronicle what is currently happening or has happened on a recreation zone (respectively, “recreation zone chatroom” and “recreation zone blog”). There may be a plurality of chatrooms and blogs associated with or displayed on the online website.

The facility optimizer 200 may also include a facility calendar module 250 which hosts a facility calendar 250a which is periodically updated to reflect the current schedule of use of the plurality of recreation zones in a facility. The facility calendar may be used to prevent an overlap of multiple users trying to rent the same recreation zone. In one embodiment the facility optimizer 200 will periodically merge information received from the facility provider on the current schedule of use of the facility with reservations from customers to maintain an updated facility calendar 250a. In an alternative embodiment the facility optimizer 200 will receive a set schedule from a facility provider for an extended period of time.

The facility optimizer 200 may also incorporate a sports league module 252 which may be used to incorporate sports league registration in addition to registration with the facility optimizer 200. The facility optimizer 200 may efficiently implement sports league registration by porting stored customer registration information into the sports league information including name, address, age, insurance coverage or the like. The sports league module 252 may be another embodiment in which interested parties such as coaches may evaluate sports players. Interested parties may provide supplemental information to users of the facility optimizer 200 that are registered in a sports league by using the facility optimizer 200 to store information such as training information in the account on the facility optimizer 200 of a user. The user can update the training information on their account or the interested party's (such as a coach) account on the facility optimizer 200 with their progress. The interested party can then supplement this information with further recommendations such as diet suggestions (e.g., EAT TO WIN) and the like.

The facility optimizer 200 presents an interface to a facility provider which allows a facility provider or manager to enter information into the facility provider template 300 as shown in FIG. 3A. Data entered by the facility manager into the facility template 300 may be stored in the facility template module 240 and/or a various plurality of memory modules in 206. The facility template 300 may include in section 300a any information necessary for a user to reserve a recreation zone in a facility or multiple recreation zones in a facility (as well as reserve multiple facilities if desired). Such information may include, but not be limited to, the name of a facility 301; the address of the facility 302; the location of the recreation zones within a facility 304; the date(s) the facility is available 306 to different types of customers (associated customers, preferred customer, or non-associated customer); the start time 308 and end time 310 on the predetermined dates that the recreation zones are available; a fee 312 which may be charged for the use of each of the recreation zones; the advance dates 314 that the recreation zones might be available for predetermined customers (e.g., associated customers or preferred customers having a higher priority over the non-associated customers (these advance dates may be at least three months ahead of the actual reservation date)); the different types of customers allowed to use the recreation zones within the facility 316; the types of prequalified customers 318 that may use the recreation zones (e.g., have insurance coverage, completed a background check); parking locations that may be available to users of the recreation zones 320; and/or detailed facility description 322 which may include rules of use, capacity, physical size, a map illustrating the location of the recreation zones inside the facility, contact information for the facility provider(s) and security, and additional services that may be offered by the facility provider (such as lining a field, lights, equipment or the like). In an alternative embodiment, if there is a fee to reserve a recreation zone, to which type of customers the fee is applicable, and whether the fee can be charged through the facility optimizer 200 by the customer or whether there is a location for the user to mail a payment for the use of the facility.

The facility template section 300b features hyperlinks that may appear to the facility provider when filling out the facility template 300. The facility provider may click on the recommend supplies link 324 and/or the recommended services link 326 to be provided with information from the facility optimizer 200 about which supplies or services the facility provider should offer to supply which are mandatory and which are optional and to allow for data entry by the facility provider. The facility provider may click on the parking pass link 328 to be provided with recommended information from the facility optimizer 200 on parking requirements and to allow for data entry by the facility manager of an institution sample parking pass template that the facility optimizer 200 can provide to users while they use the recreation zones.

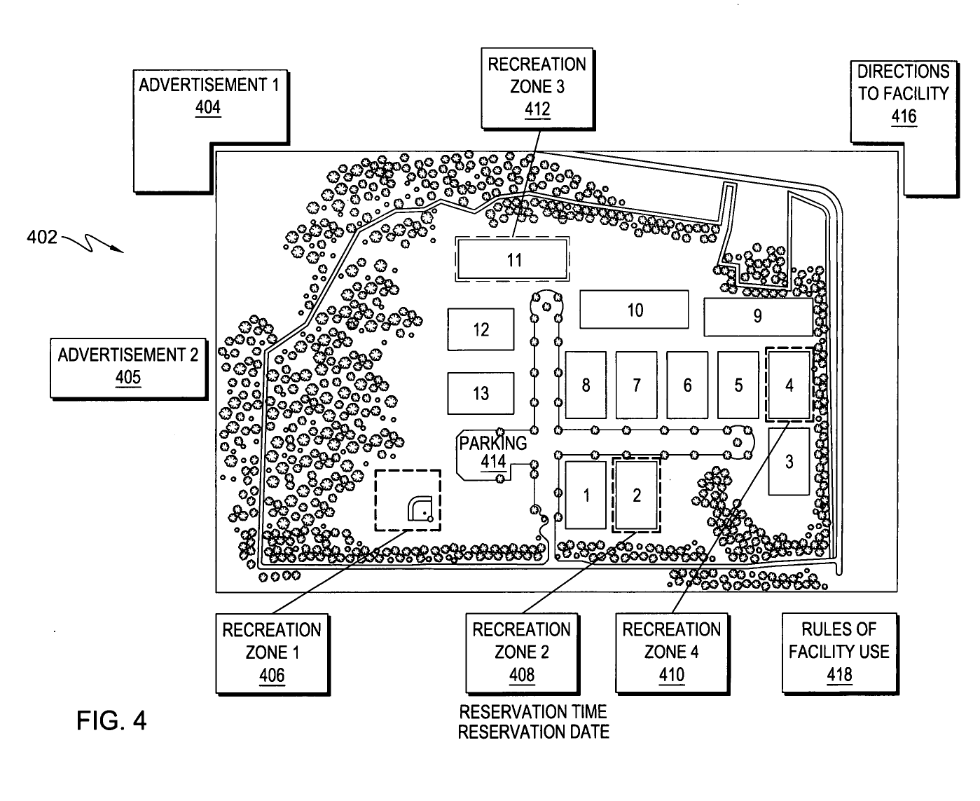

The facility provider may also clink on a map link 330 which may automatically provide a map of the facility previously stored in the facility optimizer memory 206 and the facility provider may enter information on the map about which recreation zones in which facilities are being offered for use. The facility provider should therefore be careful when entering the location or address of the facility and/or recreation zones to use precision so as to enable the customer to find the facility and/or recreation zone with particularity on a mobile device such as a mobile smartphone or mobile tablet such as an iPad® that includes a GPS if the users decide not to print out the map offered with the reservation by the facility optimizer 200. In particular, the information should include the entry of some type of regional identification information such as zip code, county, area code, and the like that would aid the user when performing a regional search of available facilities as well. The recreation information 304 as entered should include a precise description to locate the available recreation zones such as a field, court, or site within the facility that is available for reservations. For example, if the recreation zones are numbered by the facility this information may be included as well. The benefit of this feature is to avoid confusion over the actual site to be rented. In another embodiment, the facility provider may submit their own prepared map 402 as shown in FIG. 4 with the designated recreation zones 406 to 412 within the facility highlighted for the customer. The map may also designate parking location for the field 414. FIG. 4 also discloses that the map could also include directions to a facility 416 and the facility rules for use of the facility 418. As discussed below the map 402 may also include a plurality of advertising displays 404, 405.

In another embodiment, the facility template 300 could include an entry for the facility provider to include a range of fees instead of a single fee. The facility optimizer 200 may then be configured to offer a price in this range to users. The facility optimizer 200 may then use any one or all of multiple criteria to determine which fee to offer. Such multiple criteria may include the history of use of the facility, time of year, weather temperature, and/or experience with a particular user. In another embodiment, the facility optimizer 200 may base a recommended price on the ratings assigned to a facility and/or recreation zone within a facility by users.

In an alternative embodiment, the facility template 300 may have an entry if the facility provider is open to receiving bids from the prospective users. If the facility provider does not enter a lowest bid (or predetermined minimum bid) they are willing to accept, the facility optimizer 200 may be configured to arrange for a bid from a user (or user bid) to be sent to the facility provider and to receive an acceptance or rejection from the facility provider and sending a message to the user on the status of the bid. In the case of a facility or recreation zones which have large interest by many parties to reserve such as a spot on the National Mall in Washington, D.C., the facility optimizer 200 may configured to conduct an auction for the facility and/or recreation zones. In an alternative embodiment, the facility optimizer 200 will inform the user that a bid is in effect for the site and will accept bids from multiple users during the time period that the auction is in being conducted. Upon the expiration of the time period for the bid, the facility optimizer 200 will inform the users and/or the facility provider either through a display on the website 210a or through email or text messaging the results of the auction.

The facility template 300 may include an entry for the type of customers 316 that may be allowed to use the facility in terms of classification such as 1) an associated customer, 2) a preferred customer and/or 3) a non-associated customer. Alternatively, the facility template 300 may include an entry for whether the user is with an affiliated facility or an unaffiliated facility. The facility provider may send to the facility optimizer 200 for storage in memory 206 the list of associated customers and/or preferred customers so that a match can be made upon entry of this information by a user in the user reservation template 350. For example, the associated customer list may be a list of students and faculty that are part of a university. Also, as discussed below, the facility template 300 may send a list of customers who are banned from reserving a facility due to poor behavior in the past which allows the facility optimizer 200 to perform a policing function with regard to the potential users of the facility by preventing them from making reservations. Also, the facility provider may use the facility template 300 to enter the dates at which the plurality of recreation zones might be available for any or all of the associated customers, preferred customers and/or non-associated customers. When processing the customer requests to reserve a facility the facility optimizer 200 may be configured to assign reservations based on priority and may even cancel reservations based on the priority level associated with each customer as discussed below.

The prequalified customers entry 318 may be entered by name or by listing criteria that must be met to become a prequalified customer with regard to a particular facility. Prequalified customers may be those that have previously met at least one predetermined criteria designated by either a facility provider or the facility optimizer. One example of a predetermined criteria to become a prequalified customer would be to provide the proof of coverage by at least one type of insurance. In one embodiment, this proof of insurance may be presented by the user at the time of the reservation to the facility optimizer 200 and then to the facility manager. In another embodiment, the proof of insurance may be presented just to the facility optimizer 200 and the facility optimizer 200 may be configured to send a confirmation to a facility manager. In another embodiment, the proof of insurance may be stored in the memory of the facility optimizer 200 and matched to the reservation when a user is a reserving a recreation zone and then either a copy provided to a facility manager or a confirmation sent to a facility manager.

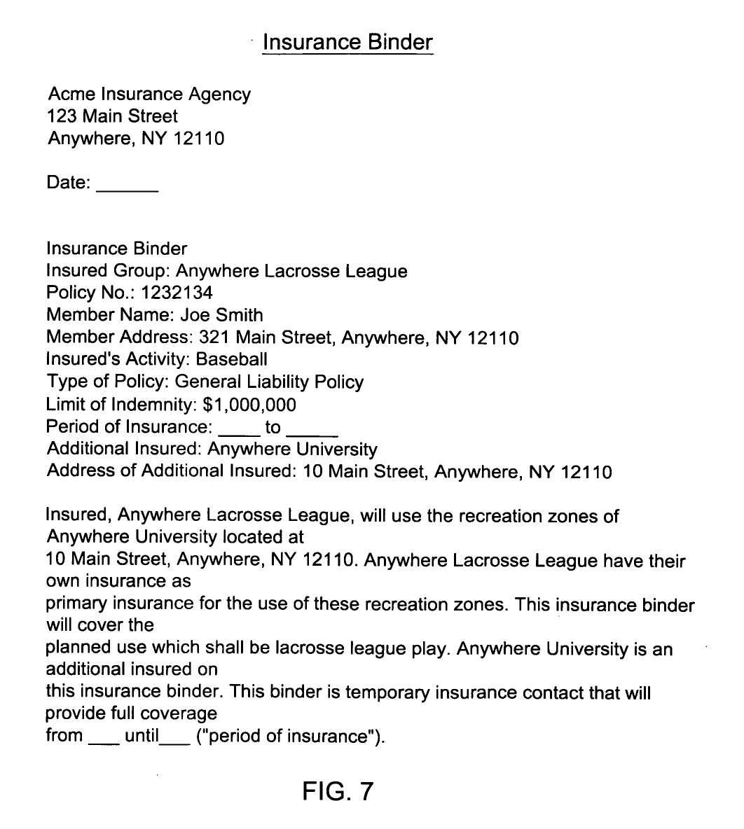

The purpose of insurance for users to play on the recreation zones of the facility is to limit the liability of the facility and/or facility provider. A prequalified customer in this example would be customers who already have proof of insurance and may have submitted it to the facility provider and/or the facility optimizer. The proof of insurance may be an actual Certificate of Insurance or an insurance binder (an example of which is shown in FIG. 7) and may be required to show that the facility is an “additional user” for purposes of insurance coverage. Many different types of insurance and the amounts of coverage may be required depending on the nature of the activity to take place at a facility. For example, a user might be required to purchase catastrophic accidental medical insurance to cover medical expenses and disability from injuries sustained during the play, practice, and general use of a recreation zone in a facility. However, some facilities might not require catastrophic accident medical insurance for some types of activities which are deemed to be low risk (e.g., using a recreation zone to play tennis). In another example, the insurance may be Accidental Insurance which would pay the medical bills for an injured user of the recreation zone. This type of insurance would cover the user or policyholder while a participant in activities in the recreation zone in the facility and/or while traveling to facility. This Accidental Insurance may be designed to provide coverage for accidental death, dismemberment, and/or accidental medical for spectators. The Accidental Insurance may be required by the facility to be supplemented by General Liability Insurance. The General Liability Insurance may provide protection for a person, team, squad, members of a league association, coaches and/or staff against claims of bodily injury, property damage liability, and/or litigation costs to defend against such claims. General Liability Insurance may, for example, be equal to or greater than $1 million per occurrence and/or equal to or greater than $3 million in the aggregate. The General Liability Insurance coverage may only be allowed if $50,000 or greater in Accidental Insurance is also purchased. The facility provider might have another predetermined criteria that each participant must complete and submit an Assumption of Risk and General Waiver of All Claims for each participant. In another embodiment, the facility optimizer 200 may be configured to notify both the facility provider and the customer that the customer insurance is getting ready to lapse on a certain date. After that certain date, the facility optimizer 200 may be programmed to prevent the customer from reserving a facility until a new Certificate of Insurance is provided. If the customers do not already have a Certificate of Insurance they may elect to purchase insurance coverage from either the facility provider or the operator of the facility optimizer 200. The facility optimizer 200 may be configured to offer this type of insurance as an additional service through a link on the online website 210a. The user may specify through the online website 210a the type and limits as well as who should be named as the additional insured as well as where and how the Certificate of Insurance or insurance binder is to be sent. It may be sent by email, SMS, facsimile and/or regular mail.

Another example of a predetermined criteria would be a second type of insurance coverage such as cancellation insurance which may be offered by the operator of the facility optimizer 200 and/or the facility provider on the online website 210a or through an email from the facility optimizer to the user which covers risk due to weather or cancellation due to unforeseen events. This second type of insurance would allow the customer to receive a credit for a future reservation either at the same facility or another facility. The facility template 300 may be configured to query the customer regarding whether they would like to purchase this type of insurance.

Another example of a predetermined criteria would be a third type of insurance coverage which may be offered by the operator of the facility optimizer 200 and/or facility provider on the online website 210a which would cover damage to the facility by the customer if it is not covered by the General Liability Insurance. The facility template 300 may also be configured to query the customer regarding whether they would like to purchase this type of insurance as well (either simultaneously with the cancellation insurance or separately).

In another embodiment, predetermined criteria to become a prequalified customers 316 might include those that have signed an agreement that requires that a customer making the reservation to inspect the field for any potential hazards at the facility prior to playing. In another embodiment, a predetermined criteria might be proof that the users or at least some of the users have completed a background check. The background check might be that of referees, coaches and/or trainers.

The facility template 300 may also include entry for the location of local medical assistance such as hospitals in case someone is injured during a facility event. In alternative embodiment, instead of the facility provider entering this information, this might be provided to the user by the facility optimizer 200 which searches for the hospital nearest the facility and lists them in an email confirmation to the user. In another embodiment, the facility optimizer 200 will request that the user fill in their health insurance information when registering at the online website 210a and will provide suggestions of medical centers that accept that type of health insurance.

Once the facility template 300 is completed by the facility provider it is sent to the facility optimizer 200. The facility optimizer 200 may then allow for the facility availability to be seen in a transparent manner by anyone interested in reserving one or more of the plurality of recreation zones in a facility (or the entire facility itself).

Note that by precisely indicating the location, date, time, and duration of a facility the facility provider will help to prevent conflict among customers. As previously discussed, if a customer does not follow the rules of the facility provider or the operator of the facility optimizer 200 when using the facility and/or the online website 210a, the customer could be prevented from making reservations in the future by either the facility optimizer operator or the facility provider. In an embodiment where the facility provider requires all customer or users to work through the facility optimizer system, the facility optimizer 200 could perform a policing function to make sure the rules with regard to the facility are followed.

In another embodiment, the facility provider may next enter the first date that the facility may be made available for reservations to the associated customers; a second date that the facility is available to the preferred customers; and a third date that the facility may be open to non-associated customers.

A benefit of the facility optimizer 200 is that it forces the facility provider (such as at a university) to plan the usage of the facility (like a football practice field) far in advance. In another embodiment, the facility optimizer 200 would be configured to divide the time period for the non-associated customers to bid into a first time period and second time period. In the first time period the non-associated customers would be allowed to put in a bid for the facility for a predetermined time period before the facility is opened up for the second time period in which the non-associated customers may reserve the facility without participating in an auction but rather would reserve the facility for a set fee. More specifically, the facility provider may designate to the facility optimizer 200 a low price to rent the facility and that would then be the price for the second time period if no user bids a greater amount during the first time period.

The facility provider may then enter a list of additional services 323 that may be offered at the facility either for free or at a charge. For example, if the facility is a baseball field then the facility provider may offer to line the field before the activity takes place, to provide speakers, and/or to provide video equipment (such as 3D video equipment). In another embodiment, the facility provider or operator of the facility optimizer 200 may offer a scoreboard or public announcement system rental. The scoreboards (where available) may have a wireless link and may be controlled via a computer smart phone, iPad® or other communication device through an application which may be downloaded from the facility optimizer 200 (or some other source).

After the facility optimizer 200 receives the fully completed or partially completed facility template 300 from the facility provider the facility optimizer 200 enters the information in the memory modules in memory 206 including the reservation module 212. In addition to the information received from the facility provider, the facility optimizer 200 may supplement the reservation database 212 or other memory modules with further enrichment information or services which may be displayed or sent to the user and would improve the user's experience. An example of further enrichment information or services may be advertising.

As previously discussed, the facility optimizer 200 may be configured to display to the user advertising for products and/or services that may be of interest to users in the activities at the facility. The advertising could be regionally based near the location that the user is considering and could be restaurants, coffee shops, or snack bars as well as sporting goods stores. In one embodiment, the facility optimizer 200 is configured to use the reservation time made by the user for a recreation zone or facility which is located near an advertiser and sends an email, text, or Facebook® posting to the user with a special offer or a reminder that the advertiser is nearby and offering some type of product or service either before, during or after the reservation time. As shown in FIG. 1, advertisers terminal 120 may transmit advertising to the facility optimizer 200 through the IP Network 106. The advertising information may be stored in an advertising module 245 as shown in FIG. 2. Therefore, as the user searches for a recreation zone(s), advertising impressions may be configured to display on the online website 210a by the facility optimizer 200 that are approximately matched by predetermined criteria with the facility as shown by reference numerals 404, 405 in FIG. 4 on the online website 210a. An example may be sporting goods for athletic events that may be conducted at the particular facility. The advertisements 404, 405 may be presented throughout the online website 210a for display to the user and become progressively more targeted as each search entry is entered by the user. For example, as the customer specifies a predetermined region the local advertising in that region might start to appear on the online website 210a. Also, if athletic events are taking place in the region that are similar in nature to the recreation zone type entered in the search made by the customer, this athletic event information might also be made available to the customer. The advertiser may explicitly or implicitly designate a target audience to the facility optimizer 200 through an advertising terminal 120 for one or more of the advertisements. If the advertising designation is explicit, the advertiser may specify an age, income level, region, or any other demographic information or any other information about a desired target audience. If the advertising designation is implicit, the advertiser may specify a particular place, time, piece of content, or other circumstance under which an ad will be shown. The circumstances specified by the marketer may favor a particular target audience. For example, if the advertisement is to be placed in a reservation for a tennis match, then the ad may be most likely to be seen by tennis fans. Therefore, such an audience may be implicitly targeted.

In one embodiment, the facility optimizer 200 may be configured to determine a target demographic for an advertiser or other party who intends to place advertisements on the online website 210a or communicate with the customers. For example, the advertiser may have specified the target audience, or the advertiser may have specified where his ads are to be placed, thereby allowing an inference to be made by the facility optimizer 200 as to the advertiser's target audience.

In one embodiment, the advertisement may be based on information provided by the users when registering at the online website 210a. Once customers have been found who fall within a target demographic for an advertiser, the advertisements of the advertiser may be shown to such customers. In one embodiment, if an advertiser has purchased greater than 1000 impressions on the online website 210a for his advertisement, the advertisement may be shown over 1000 times to users. If an advertiser has purchased a prominent display area or more targeted advertising for his advertisement on the online website 210a, the impressions shown may number less than 1000 times due to the quality of the impression. Therefore, the facility optimizer 210a is configured to charge predetermined amounts for the advertising impressions depending on the range of quality of the impressions. For high quality impressions (such as larger or more demographically targeted advertising) the facility optimizer 200 may charge greater amounts than for low quality impressions (such as less prominent and less targeted advertising impressions). The predetermined amounts charged by the facility optimizer 200 may also vary, for example, on whether the advertisement is shown in a large or prominent portion of a display screen of a mobile device which is determined by the facility optimizer 200 from the GPS device in the mobile device to be located near the an advertiser's location or on a stationary pc terminal. In another embodiment, an advertiser may originally submit advertisements to an advertising network on the IP Network 107 such as the Internet which would then utilize the facility optimizer 200. The advertising network may include a business, website, exchange, or other entity that receives advertisements and places (or “serves”) the advertisements with appropriate content providers.

In an alternative embodiment, promotions targeted at a user may follow a customer's movements through the GPS in a mobile device. For example, as a customer moves along a path, advertising displays along the path may display promotions directed at the customer. The promotions may include personalized information, such as a name of the person, his friends, his address, and/or any information obtained about his preferences or events he has been involved in. The promotions may include audio directed at the person, such as a reference to the person by name.

As discussed above, the facility optimizer 200 may offer products and/or services to users of the online website 210a. These products and/or services may be characterized as “enrichment” services and/or products to enrich the experience of the user with the facility optimizer. An example of an enrichment service offered by the facility optimizer 200 to the user on the online website 210a is an opportunity to purchase insurance coverage just for the use of the facility from a third party either during the reserved time or over the course of another specific time. Another example of an enrichment service is an opportunity to rent equipment for the event (e.g., such as a blow up balloon for a birthday party or a clown); the chance to hire a coach or tutor to be available at the site during the reservation; or deals at local restaurants. The operator of the facility optimizer 200 may then collect fees from advertisers for offering these services.

Another example of an enrichment service that may be provided either by the facility provider and/or the operator of the facility optimizer 200 is an offer to either cancel the reservation or switch the reservation based on a desire by another customer to use the facility at the same time. The original user may then be offered a discount credit by the facility optimizer 200 through the website 210 towards their next reservation to make the switch.

Another enrichment service that may be performed by the facility optimizer 200 would be to offer up additional facility or recreation zones within the time and/or region selected by the customer in case his original choice is unavailable.

Another enrichment service that may be performed by the facility optimizer 200 is to provide email, text or Facebook® notifications on a customer list to update the customers of the status of the facility or remind them that they have not used the facility optimizer 200 or recreation zones of the facilities in a certain time period. In an embodiment whereby a fee may or may not be paid by the customer to rent the facility, the operator of the facility optimizer 200 may charge the customer a fee (e.g., $1.00) for email, text and/or Facebook® updates depending on the size of the customer list and the frequency of the updates. In another embodiment, the facility optimizer 200 may be programmed to provide at least one or a plurality of updates to the customer list about relevant recreation zone use information such as organizing car pools.

Another enrichment service of the facility optimizer 200 is that it is configured to charge the credit cards of the customers upon the making of the reservation. If the recreation zone reservation is cancelled due to inclement weather or some other uncontrollable circumstance, the charge may be credited back to the customer if the customer does not want to accept a credit for a free reservation. The share of the income due to the facility provider may be paid upon successful use of the reserved recreation zone. In another embodiment, the facility provider may have the capability to cancel all activities through the facility optimizer 200 by indicating to the facility optimizer 200 that email notification to the users should be sent out or a posting should be made on user's or the institutions social networking pages or an institution's website 210b.

Another enrichment service of the facility optimizer 200 is to provide as a viewing option on the online website 210a the rank of each of the facilities and/or recreation zones, for example, by price (low or high), previous user ratings, closeness, and/or size. In another embodiment, the facility optimizer 200 may provide a first facility location map for the user to view when making a reservation of the plurality of facilities that are available. In another embodiment, the facility optimizer 200 may show on the display of the online website 210a a second recreation zone map of the plurality of recreation zones within the facility when the user clicks on the indicator on the first facility location map. In another embodiment, a combined map will show not only the facility available but simultaneously display within each of the facility the plurality of recreation zones that are available (“facility and recreation zones simultaneous display map”).

Another enrichment service provided by the facility optimizer 200 may include the ability to review users' data in the memory 206 and offer the facility provider a recommended price to charge for the use of the recreation zones in the facility (“price recommendations”). In one embodiment these price recommendations may be based on, but not limited to, review and measurement by the facility optimizer 200 of a plurality of use criteria. Such use criteria may include past prices for this type of facility in the region, the time of year (Summer vs. Winter), the time of day, and/or past use history of the same or different customers. In addition to the price recommendations the facility optimizer 200 may also send the facility provider a periodic reminder that at least one recreation zone or a plurality of recreation zones have not been rented in awhile or at a certain time period and a suggestion that the facility provider might drop his price overall or during that certain time period. An additional enrichment service of the facility optimizer 200 would be to offer the facility provider information such as Revenue Per Available Facility Site (or Revenue Per Available Recreation Zone), Average Daily Rate (ADR) and Average Hourly Rate (AHR) so that the facility provider can make more informed decisions. In another embodiment, the facility optimizer 200 might review statistical information on a regional or national basis in making recommendations of what fee for a facility provider to charge for the use of at least one recreation zone or a plurality of recreation zones in a facility.

Another enrichment service provided by the facility optimizer 200 would be to provide an open matching system to approximately match a first user with a second, third or plurality of users who might want to share a recreation zone in a facility. An example of this would be a tennis player who needs a partner to play and provides a notification on the online website 210a that the tennis player is looking for another player and can specify the level of the desired player. The level of play and certain other criteria may be analyzed by the facility optimizer 200 to approximately match opponents of substantially the same ability.

Another enrichment service provided by the facility optimizer 200 may be to allow recreation service providers using a recreation service provider terminal 122 as shown in FIG. 1 to offer their services to users of the facility optimizer 200. Such recreation service providers may include fitness trainers, tutors, referees, equipment suppliers or the like which, in at least one embodiment, have their advertisements matched by the facility optimizer 200 with the type of recreation zone that the recreation service provider 122 would optimally fit. Hiring a recreation service provider 122 through the facility optimizer 200 may allow for their payment and eliminate the need for payment in cash. In another embodiment, recreation service providers or equipment suppliers may be ranked by 1) users' input; 2) the facility optimizer 200 after reviewing their credentials and/or experience; or 3) both. The results may be displayed on the display screen of the online website 210a.

Another enrichment service provided by the facility optimizer 200 may be to operate an automated confirmation system for recreation service providers. For example, an automated referee confirmation system may be implemented when a user requests a referee from the facility optimizer 200 which then searches for approximate matches based on age level of the teams, time for availability such weekdays and weekends, the referees experience and licenses as well as geographic proximity to the facility. A request may be transmitted from the user to the facility optimizer 200 which would then automatically contact the first choice of the referees and provide a designated number of hours to confirm before the next best match is contacted. Payments for the referee may be received from the user through the facility optimizer 200 and disbursed to the referee. In addition, a service provider such as a referee or scorekeeper may input scores from a mobile device to be displayed on the online website 201a or distributed to user designated addresses by email, text and/or social network posting.

In another embodiment, the facility optimizer 200 may be configured to communicate to a plurality of members of sports leagues (stored in the sports league module 252) for player identification cards in electronic formats so coaches and/or referees can check in players without the need for actual hardcopy credentials.

In another embodiment, the facility optimizer 200 may be configured to offer frequent rental rewards program which may be linked with an online merchandise provider.

In an alternative embodiment, users such as coaches may check in other participants such as players and keep their records secure on the online website 210a such as attendance. This participant information may or may not be kept in a secure area on the online website 210a. Users can use the facility optimizer 200 to post either in real time and/or post contest game records as sports contests on the recreation zones progress which may either be public or viewed with a password by other users or interested parties. Records such as shots on goal, assists, saves, and/or corner kicks can all be recorded and posted to the online website 210a and then viewed by other users such as interested parties (e.g., college coaches) looking for prospects.

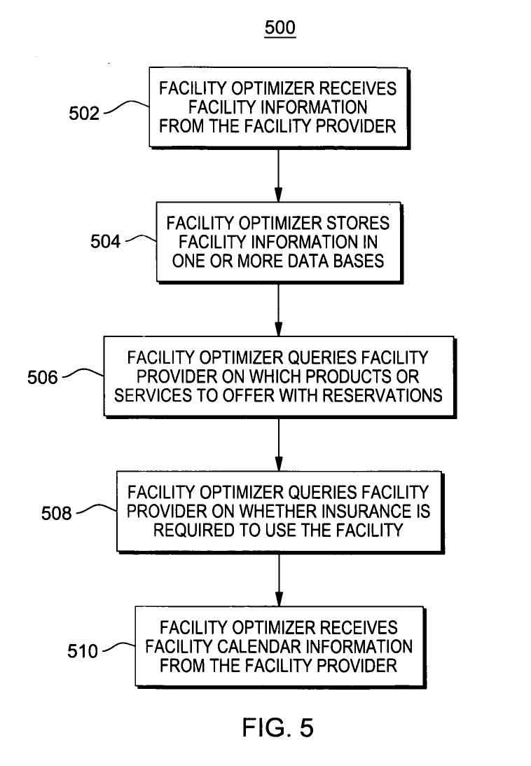

FIG. 5 is a flowchart 500 of an exemplary embodiment of a facility information entry process using the facility provider template 300 of the facility optimizer 200. In step 502 the facility optimizer 200 receives information on the facility from a facility provider as described above which may include: a description of the facility (including capacity and size); the price to be charged for the use of the facility; the site of the facility (address including zip code); the recreation zone or plurality of recreation zones within the facility which are available for reservations including a map to show their positions within the facility; available dates, available times and available duration that a recreation zone within the facility is available.

In step 504 the facility optimizer 200 is configured to store this facility information received from the facility provider in one or more databases. In step 506 the facility optimizer 200 queries the facility provider on which services or products are authorized to be offered to customers who reserve the recreation zones in the facility. In step 508 the facility optimizer 200 also queries the facility provider on whether insurance is a predetermined criteria to reserve the facility. If insurance is required, then that will be a predetermined criteria if a customer wishes to be considered a prequalified customer in this embodiment and reserve a recreation zone in the facility. In step 510 the facility provider may periodically update the facility calendar 250a stored on the facility optimizer which is available for view by the facility provider at the online website 210a so that the use of the recreation zones in the facility can be efficiently optimized.

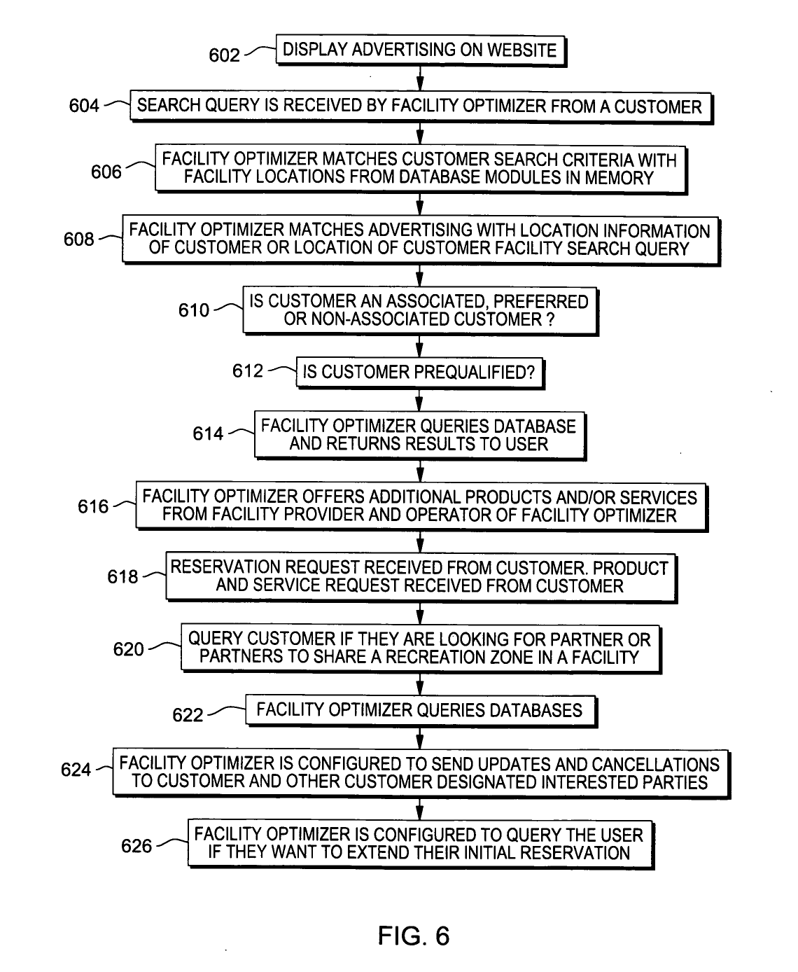

FIG. 6 is a flowchart 600 of a facility reservation process using the user reservation template 350 of the facility optimizer 200 according to an embodiment. In step 602 advertising is displayed on the online website 210a. The advertising may be either nationally, regionally or locally directed or targeted in another manner as discussed above. In step 604 the facility optimizer 200 receives a search query from a customer. In entering the search query on the online website 210a and sending the search query to the facility optimizer 200 the customer specifies reservation criteria including the location. In step 606 upon receiving the search query from the customer, the facility optimizer 200 approximately matches the query with the available at least one or a plurality of recreation zones in memory. In step 608 the facility optimizer 200 may be configured to change the advertising on the website 210a in scope approximately centered around the search location for the recreation zones, the current location of the user or another address indicated by the user. The advertising may be changed from 1) nationally directed to regionally directed advertising; 2) nationally directed to locally directed advertising; 3) from regionally directed advertising to locally directed advertising; 4) locally directed advertising to regionally directed advertising; 5) locally directed advertising to nationally directed advertising; and/or 6) regionally directed advertising to nationally directed advertising. Nationally directed advertising is that for businesses that are substantially located in most areas of the nation; regionally directed advertising is for businesses which are offering products and/or services within approximately sixty miles of the user's current location, the user's designated facility search location or another location indicated by the user; and locally directed advertising within five miles of the user's current location, the user's designated facility search location or another location indicated by the user. The change from national to regional to local advertising may be sent to the user's display 1) in response to different search queries or webpage changes received from the user; 2) in a continuous dynamic (or changing) way even if the user does not change the same webpage; and/or 3) in a semi-continuous dynamic way. The search location may be defined as 1) an address such as a street address; 2) a broader region such as a zip code; and/or 3) it may be a range chosen by the user such as within approximately 5 miles of the street address chosen by the user in the search query. For example, advertising for products or services in the approximate area (“advertising approximate area”) of the facility might substantially match the nature of at least one of the recreation zones in the facilities. The advertising approximate area might be 1) within a range of less than half a mile around a search location; 2) from half a mile to a mile of the search location on any side of a search location or just one or several sides of a search location; or 3) within one to five miles of a search location on any side of a search location or just one or several sides of a search location. Alternatively, the facility optimizer 200 may configure the online website 210a to just show national, regional or local advertising continuously from the moment the user connects to the online website 210a based on the facility optimizer 200 automatically determining the location of the user. In determining a query match the facility optimizer 200 may determine if the customer is an associated customer, preferred customer or non-associated customer in step 610. Accordingly, the facility optimizer 200 may be configured to return a search with facilities that are appropriate for the type of customer. Also, in step 612 the facility optimizer will determine if the customer is a prequalified customer (e.g., has the insurance coverage, background check or the like) and sends a selection of recreation zones in the facility to the user. In step 614 if a match is found, a list of available recreation zones and/or facilities are displayed for the customer through the online website 210a. In step 616 along with the list of recreation zones the facility optimizer 200 will also display 1) facility offered services and 2) facility services offered by the operator of the facility optimizer 200 through the facility optimizer 200. In an alternative embodiment in step 616 the operator of the facility optimizer 200 may also offer any or all of a first, second or third types of insurance as previously discussed. In this embodiment, the first type of insurance may be injury insurance, the second type of insurance is cancellation insurance and the third type of insurance may be for damage to a recreation zone in a facility. In step 618, a reservation request for a recreation zone or plurality of recreation zones is received from the user as well a request from the user for facility offered services and/or facility services offered by the operator of the facility optimizer. In step 620 the facility optimizer will offer a matching service whereby the user may be matched with other customer profiles with similar interests or customer profiles of customers located near the facility to see if there is interest in making a connection. In step 622 the facility optimizer 200 will conduct a search of the databases in memory 206 to see if there is a match and display results for the user. In step 624 the facility optimizer 200 is configured to send the customer and other designated interested parties updates on their reservations including cancellations due to weather or individual cancellations by the customers or designated interested parties. In step 626, the facility optimizer 200 may be configured to offer the user an extension on the initial reservation at the same recreation zone or at an approximately located recreation zone either before, during or after the occurrence of the user reservation, if the recreation zone is available. In one embodiment, the extended reservation may be offered at a reduced fee.

The foregoing description has been presented for purposes of illustration and description and is not intended to be exhaustive or to limit the embodiments to the precise form disclosed. Many modifications and variations are possible in light of the above teaching. The embodiments were chosen and described to best explain the principles of the disclosure and its practical application to thereby enable others skilled in the art to best use the various embodiments disclosed herein and with various modifications suited to the particular use contemplated. The actual scope of the invention is to be defined by the following claims.

1. A system comprising:
a communications interface adapted to interface with a network; a processor coupled to the communications interface and adapted to:
receive facility information from a plurality of facilities wherein said facility information includes recreation zones;
receive a facility search request from a user;
search at least one database to determine if there is an approximate match with the facility search and send the response to the user; and
receive a request to reserve at least one of the recreation zones within the plurality of facilities.

2. The system of claim 1, wherein the processor is configured to determine if the user is prequalified.

3. The system of claim 2, wherein the processor is configured to determine if the user is prequalified by determining if the user has insurance coverage.

4. The system of claim 1, wherein the processor is configured to substantially match the facility information with additional services provided by the system.

5. The system of claim 1, wherein the facility information includes capacity information.

6. The system of claim 1, wherein the facility information includes facility offered services.

7. The system of claim 1, wherein the facility information will include a map showing the location of the recreation zone within the facility.

8. The system of claim 1, wherein the controller provides advertising that corresponds to the type of facility being searched by the user and sends the advertising to a website.

9. The system of claim 1, wherein the facility is a private institution.

10. The system of claim 1, wherein the additional services offered by the system include insurance coverage for use of at least one of the recreation zones.

11. The system of claim 1, wherein the controller receives from the user whether they are an associated customer.

12. The system of claim 1, wherein the controller is configured to send a message to a facility provider when the facility has not been rented in a predetermined time period to indicate that the facility provider should alter the rental price.

13. A method comprising:
receiving facility information from a plurality of facilities wherein said facility information includes a plurality of recreation zones;
receive a facility search request from a user;
searching at least one database to determine if there is an approximate match with the facility search and send the response to the user; and
receiving a request to reserve at least one of the recreation zones within the plurality of facilities.

14. The method of claim 13, further comprising:
receiving videos from users and storing them in an augmented reality format.

15. The method of claim 13, further comprising:
sending a request to a user asking if the user is a prequalified customer.

16. The method of claim 13, further comprising:
sending a request to a user inquiring if they are covered by insurance.

17. The method of claim 13, further comprising:
sending advertising to the user's display based on the location of the facility search request.

18. The method of claim 13, wherein the facility information may include a map with the recreation zones indicated.

19. The method of claim 13, further comprising:
sending advertising to the user's display in a dynamic way from regional to local advertisers.

20. A computer program comprising a computer usable medium having a computer readable program code embodied therein, said computer readable program code configured to:
receive facility information from a plurality of facilities wherein said facility information includes a plurality of recreation zones;
receive a facility search request from a user;
search at least one database to determine if there is an approximate match with the facility search and send the response to the user; and
receive a request to reserve at least one of the recreation zones within the plurality of facilities.
